(19) United States
(12) Patent Application Publication
(10) Pub. No.: US 2017/0158276 A1
(43) Pub. Date: Jun. 8, 2017

(54) MOBILITY SCOOTER WITH SLIDE OFF SEAT

(71) Applicant: Tony Streiling, Paso Robles, CA (US)

(72) Inventor: Tony Streiling, Paso Robles, CA (US)

(21) Appl. No.: 14/960,407

(22) Filed: Dec. 6, 2015

(51) Int. Cl. B62K 3/16

(52) U.S. Cl. CPC B62K 3/16

(57) ABSTRACT

The system of the preferred embodiments includes at least two wheels, where the wheels are mounted on axles, where the axles are attached to a frame, where a seat is attached to the frame, where the seat is designed to allow a user to slide along the seat and off of at least one end of the seat. The mobility scooter of the preferred embodiments is designed to allow a user to slide from the seat of the scooter directly onto other types of seats, and then slide back onto the scooter, allowing the user to get around much more easily and with far less strength that they would have to with any other type of scooter or wheelchair.

### BRIEF DESCRIPTION OF THE FIGURES

FIG. 1 is a schematic representation of the system of the first preferred embodiments viewed from the side.

FIG. 2a is a schematic representation of the system of the first preferred embodiments with two wheels viewed from the top.

FIG. 2b is a schematic representation of the system of the first preferred embodiments with four wheels viewed from the top.

FIG. 3 is a schematic representation of the system of the first preferred embodiments viewed from the side, where the scooter has a handle attached to the frame.

FIG. 4a is a schematic representation of the system of the first preferred embodiments with two wheels viewed from the top, where the scooter has a handle attached to the frame.

FIG. 4b is a schematic representation of the system of the first preferred embodiments with four wheels viewed from the top, where the scooter has a handle attached to the frame.

FIG. 5 is a schematic representation of the system of the first preferred embodiments viewed from the side, where the user can slide off at least one end of the seat.

FIG. 6a is a schematic representation of the system of the first preferred embodiments with a handle viewed from the side, where the scooter seat is designed to be at a similar height to common furniture.

FIG. 6b is a schematic representation of the system of the first preferred embodiments with a handle viewed from the side, where the scooter seat is designed to be at a similar height to common toilets.

FIG. 6c is a schematic representation of the system of the first preferred embodiments with a handle viewed from the side, where the scooter seat is designed to be at a similar height to common vehicle seats.

FIG. 7a is a schematic representation of the system of the first preferred embodiments with a handle viewed from the side, where the scooter seat is designed to be capable of being positioned close enough to common furniture that a user can slide from the scooter seat onto the furniture.

FIG. 7b is a schematic representation of the system of the first preferred embodiments with a handle viewed from the side, where the scooter seat is designed to be capable of being positioned close enough to common toilets that a user can slide from the scooter seat onto the toilet.

FIG. 7c is a schematic representation of the system of the first preferred embodiments with a handle viewed from the side, where the scooter seat is designed to be capable of being positioned close enough to common vehicle seats that a user can slide from the scooter seat onto the vehicle seat.

FIG. 8 is a schematic representation of the system of the first preferred embodiments viewed from the side where the seat is positioned such that the users feet can comfortably reach the ground, and the seat and frame are designed so that the user can utilize their feet to provide motive force to the scooter.

FIG. 9a is a schematic representation of the system of the first preferred embodiments viewed from the side, where the scooter seat is designed to be capable of being positioned close enough to common furniture that a user can slide from the scooter seat onto the furniture.

FIG. 9b is a schematic representation of the system of the first preferred embodiments viewed from the side, where the scooter seat is designed to be capable of being positioned close enough to common toilets that a user can slide from the scooter seat onto the toilet.

FIG. 9c is a schematic representation of the system of the first preferred embodiments viewed from the side, where the scooter seat is designed to be capable of being positioned close enough to common vehicle seats that a user can slide from the scooter seat onto the vehicle seat.

FIG. 10a is a schematic representation of the system of the first preferred embodiments viewed from the side, where the scooter further includes two or more wheels sized sufficient to allow the user to apply motive force to the wheels with their hands, where the scooter seat is designed to be capable of being positioned close enough to common furniture that a user can slide from the scooter seat onto the furniture.

FIG. 10b is a schematic representation of the system of the first preferred embodiments viewed from the side, where the scooter further includes two or more wheels sized sufficient to allow the user to apply motive force to the wheels with their hands, where the scooter seat is designed to be capable of being positioned close enough to common toilets that a user can slide from the scooter seat onto the toilet.

FIG. 10c is a schematic representation of the system of the first preferred embodiments viewed from the side, where the scooter further includes two or more wheels sized sufficient to allow the user to apply motive force to the wheels with their hands, where the scooter seat is designed to be capable of being positioned close enough to common vehicle seats that a user can slide from the scooter seat onto the vehicle seat.

FIG. 11 is a schematic representation of the system of the first preferred embodiments viewed from the side, where the scooter further includes two or more wheels sized sufficient to allow the user to apply motive force to the wheels with their hands.

FIG. 12 is a schematic representation of the system of the first preferred embodiments viewed from the end, where the scooter further includes two or more wheels sized sufficient to allow the user to apply motive force to the wheels with their hands.

FIG. 13a is a schematic representation of the system of the first preferred embodiments viewed from the end, where the scooter has two wheels and the axles are attached to the frame.

FIG. 13b is a schematic representation of the system of the first preferred embodiments viewed from the end, where the scooter has four wheels and the axles are attached to the frame.

FIG. 14 is a schematic representation of the system of the first preferred embodiments viewed from the side, where the user utilizes the handle to aide them in sliding onto the seat.

FIG. 15 is a schematic representation of the system of the first preferred embodiments viewed from the side, where the scooter further includes two or more wheels sized sufficient to allow the user to apply motive force to the wheels with their hands, where the scooter further includes a pad the user can lean their upper body against.

FIG. 16 is a schematic representation of the system of the first preferred embodiments viewed from the side, where the seat height is adjustable.

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### 1. First Preferred Embodiment

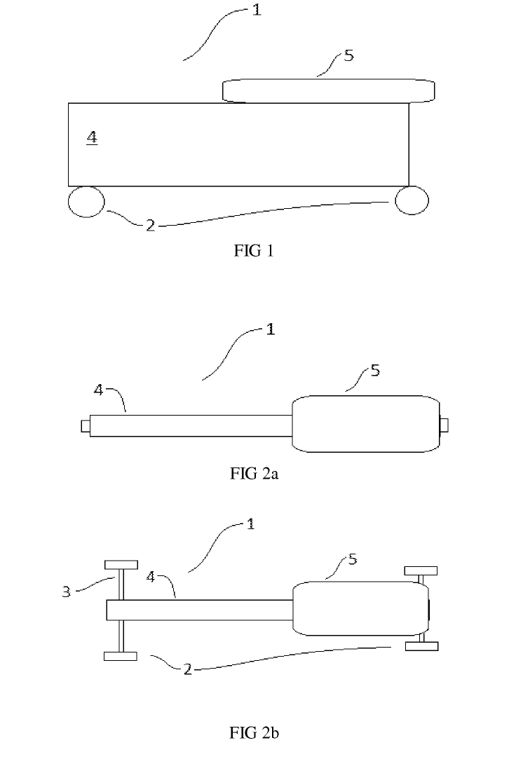

As shown in FIG. 1, the system of the preferred embodiments includes at least two wheels 2, where the wheels 2 are mounted on axles, where the axles 3 are attached to a frame 4, where a seat 5 is attached to the frame 4, where the seat 5 is designed to allow a user 6 to slide along the seat 5 and off of at least one end of the seat 5. The mobility scooter 1 of the preferred embodiments is designed to allow a user 6 to slide from the seat 5 of the scooter directly onto other types of seats 5, and then slide back onto the scooter, allowing the user 6 to get around much more easily and with far less strength that they would have to with any other type of scooter or wheelchair.

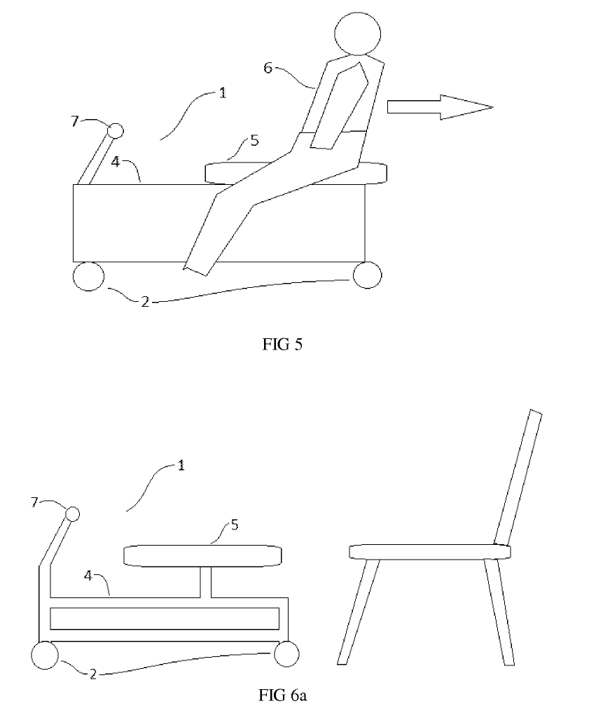

As shown in FIGS. 2a and 2b, the frame 4 is preferably designed to allow the user 6 to easily slide onto and off of at least one end of the seat 5, as shown in FIG. 5. The frame 4 members could block the user 6 from sliding onto and off of the scooter if they protruded into the path of the user's body parts in the range of sliding motion of the user. In a preferred embodiment, the support frame 4 is contained below the seat 5 and is narrower than the top surface of the seat 5. In a preferred variation, the frame 4 is constructed of tubing which can be made of any suitable material. In another preferred variation, the frame 4 is constructed of formed polymer members. In another preferred variation, the frame 4 is constructed of formed metal sheet. In another preferred variation, the frame 4 is constructed of composite material. The frame 4 may, however, be constructed of any suitable material. The frame 4 may, however, have any suitable design and positioning that does not prevent the user 6 from sliding off at least one end of the seat 5.

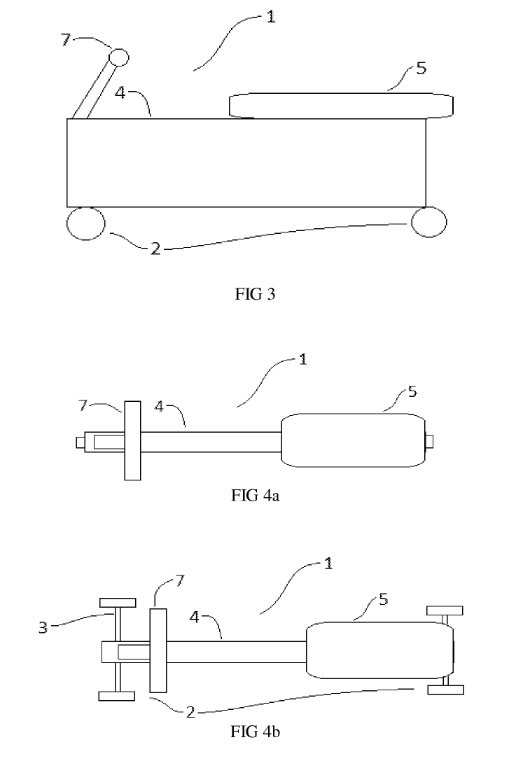

As shown in FIGS. 3, 4a, and 4b, in a preferred variation the mobility scooter 1 further includes a handle 7 attached to the frame 4. The handle 7 preferably provides the user 6 a means to stabilize themselves on the scooter, and to control the direction and motion of direction of the scooter during use. In one preferred variation, the handle 7 extends above the level of the seat 5. In a further variation, the handle 7 is positioned and designed such that when the user 6 is sitting on the seat 5, they can lean forward and grab the handle 7 and comfortably lean some of their weight onto the handle 7. In a further variation, the handle 7 is a mostly horizontal round handle 7 supported by a tube raising above the frame 4, and connected to the frame 4 on one end and the horizontal round handle 7 at the other end. In another variation, the handles 7 are at the same level as the seat 5 and run nearly parallel to the frame 4. The handle 7 may, however, have any suitable design. As shown in FIG. 14, the handle 7 preferably can be utilized by the user 6 to pull on with their hands and help slide themselves onto the seat 5 of the scooter. The handle 7 may, however, be used for any suitable purpose. The scooter may, however, include any type of handle 7. The scooter may include no handle 7 at all. The scooter may include any suitable means for stabilizing the user. The scooter may include no means for stabilizing the user 6 at all. The scooter may include any suitable means for controlling the direction and motion of the scooter while in use.

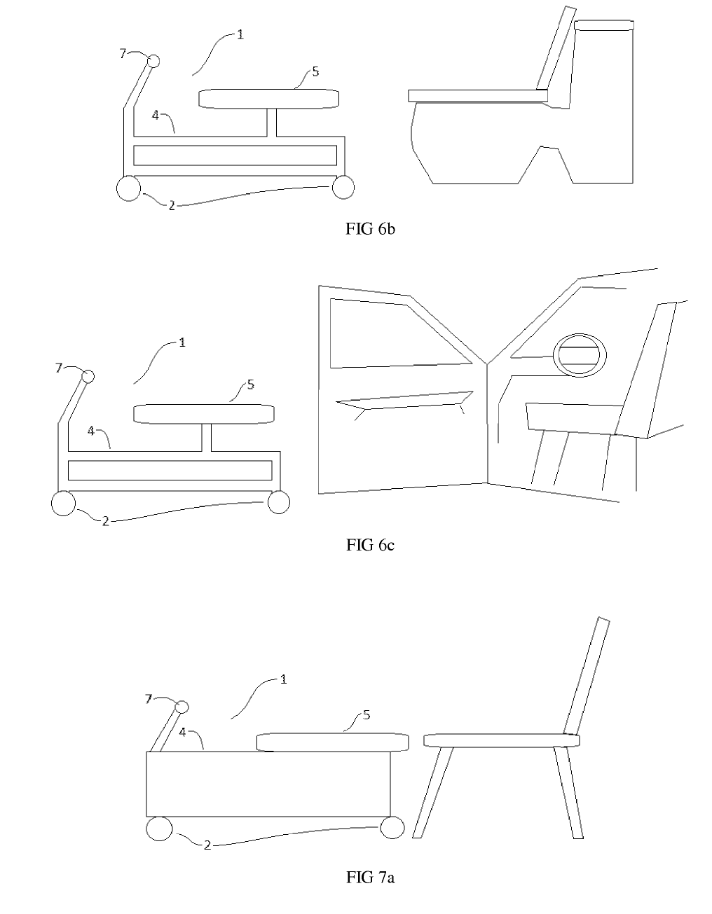

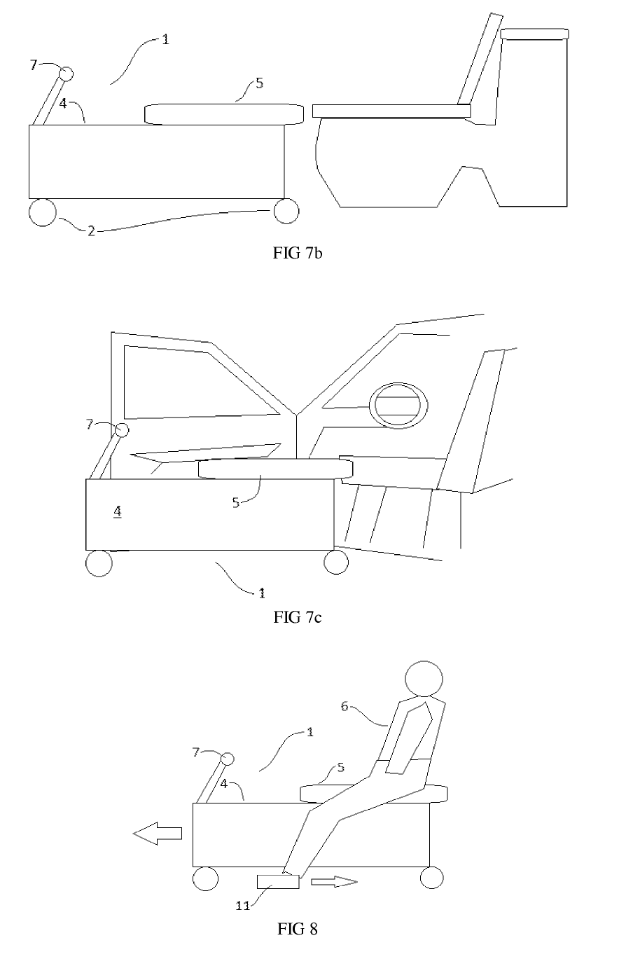

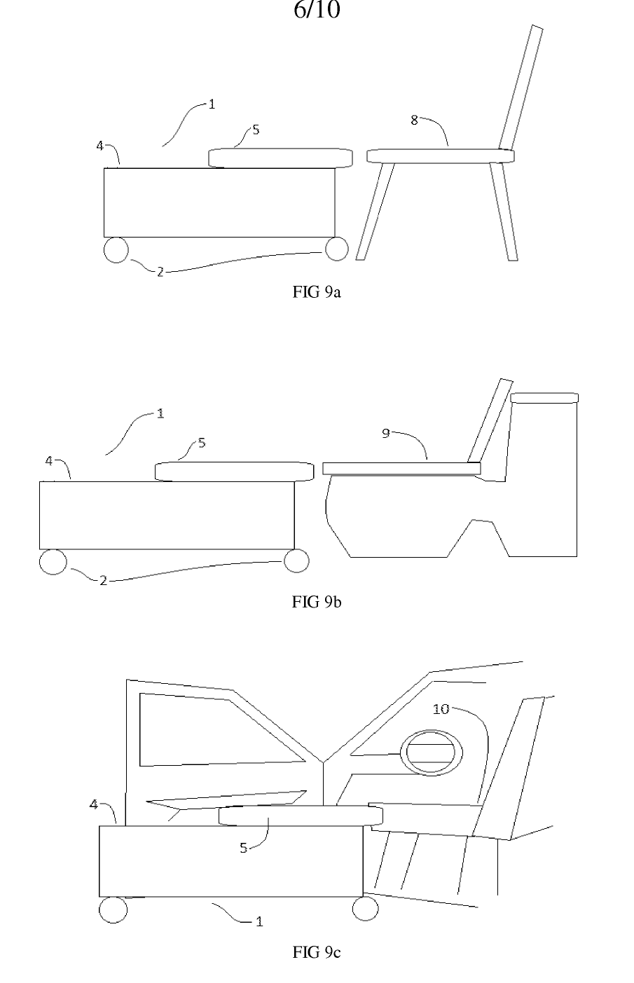

As shown in FIGS. 6a, 6b, and 6c, the seat 5 of the mobility scooter 1 is preferably designed to be roughly the same height as one or more of common pieces of furniture 8, common toilets 9, and common vehicle seats 10. In a variation, the seat 5 is attached to an adjustable frame 4 member that allows the height of the seat 5 to be adjusted. In a further variation, the seat 5 is attached to a hexagonal frame 4 section with frame 4 members attached to one another with pivoting joints and a lead screw threaded through threaded couplers in the middle joints, in a construction similar to a prior art car jack, allowing the seat 5 to be easily raised up and down. The seat 5 may, however, have any suitable attachment to the frame 4. The seat 5 may, however, not be adjustable at all. As shown in FIGS. 7a, 7b, and 7c, the frame 4 and seat 5 of the mobility scooter 1 are preferably designed and positioned such that the seat 5 of the scooter can be positioned close enough to one or more of common pieces of furniture 8, common toilets 9, and common vehicle seats 10 to allow the user 6 to slide from the seat 5 of the scooter onto the one or more of common pieces of furniture 8, common toilets 9, and common vehicle seats 10. This sliding transfer preferably requires very little strength and physical effort, allowing elderly and disabled users to move around and utilize one or more of furniture around their environment, bathrooms, and vehicles even if they would not otherwise be physically capable of moving themselves around and transferring themselves to one or more of furniture 8, toilets 9, and vehicle seats 5. Scooters and wheelchairs found in the prior art do not provide a means for sliding transfers onto any of furniture 8, toilets and vehicle seats 5. The sliding transfer is preferably performed with the user 6 sliding backwards off the seat 5 onto the one or more of furniture 8, toilets or vehicle seats 5. Prior art scooters and wheelchairs do not provide an easy means for the user 6 to slide off the back of the seat 5, and do not also do so without any components obstructing the sliding path, and do not also do so while having seat 5 heights appropriately matching common furniture 8, toilets 9, and vehicles seats 5. The seat 5 may, however, allow the user 6 to slide off any appropriate side of the seat 5. As shown in FIG. 8, in one preferred variation, the seat 5 height and design allow the user's feet 11 to comfortably touch the ground so that the user 6 can use their feet 11 to provide force to move the scooter. In this preferred variation, the frame 4 is also preferably designed to allow the user 6 a free range of motion to use their feet 11 to move the scooter. The seat 5 may, however, be at any suitable height.

As shown in FIGS. 2a and 2b, the mobility scooter 1 has at least two wheels 2. In one preferred configuration the mobility scooter 1 has four wheels 2. In another preferred configuration the mobility scooter 1 has two wheels 2. In another variation the mobility scooter 1 has three wheels 2. The mobility scooter 1 may, however, have any suitable number of wheels 2.

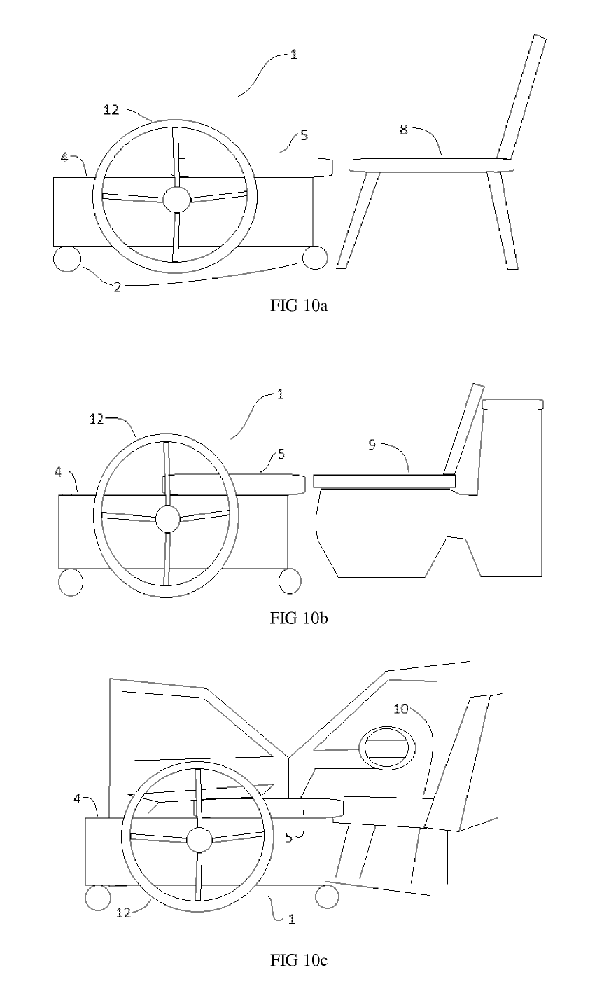

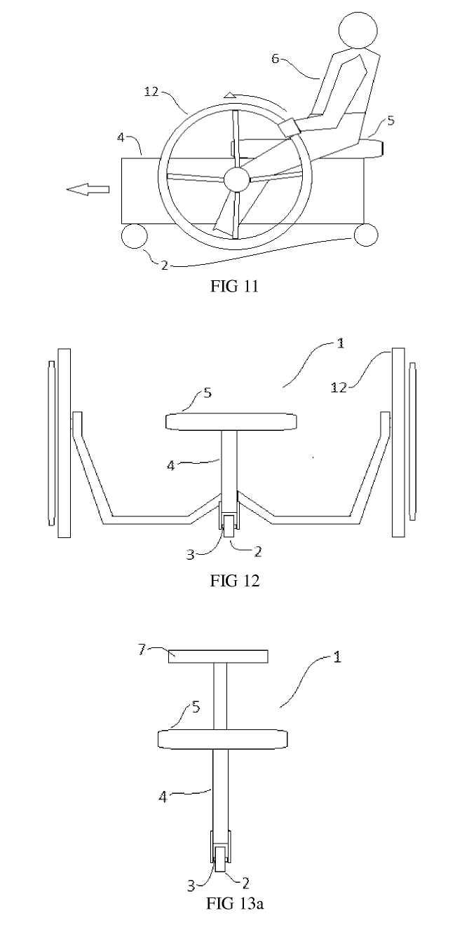

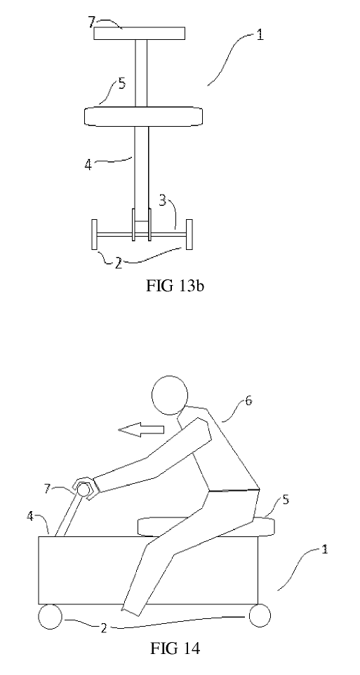

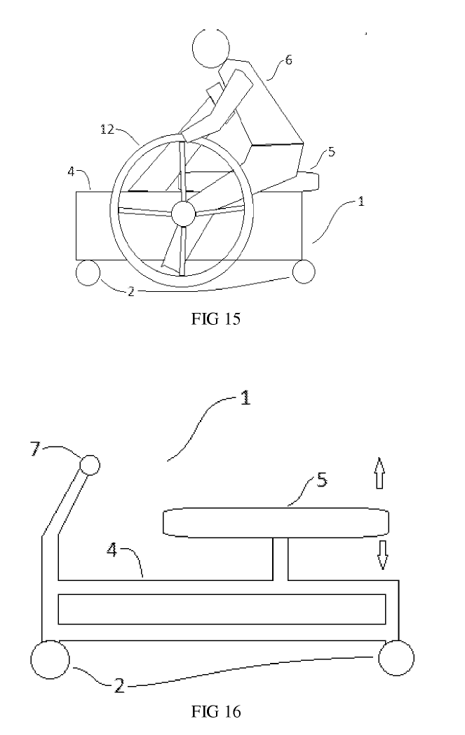

As shown in FIGS. 10a, 10b, and 10c, in another preferred variation the mobility scooter 1 includes at least two wheels 2 sized properly that the user 6 can turn the wheels 2 with their hands, as shown in FIG. 11. Preferably these wheels 2 include an annular handle 7 for turning the wheels 2. In this variation the wheels 2 may be constructed similarly to wheelchair wheels 2. In another variation the wheels 2 may be identical to wheelchair wheels 2. The wheels 2 may, however, have any suitable design allowing the user 6 to turn the wheels 2 with their hands. In a preferred variation, the wheels 2 are canted inward to allow the user 6 to more easily turn the wheels 2. The wheels 2 may, however, be situated in any suitable manner. As shown in FIG. 12, the larger wheels 12 are preferably mounted to frame 4 members that attach to the axle 3 of the larger wheels 12, then extend downward and under the feet 11 of the user 6 to attach to the frame 4 of the mobility scooter 1. This preferably allows the user 6 to slide onto and off of the seat 5 without being obstructed by any frame 4 members attaching the larger wheels 12 to the mobility scooter 1. In a preferred variation, a tray is attached to the bottom of the frame 4 members to provide a platform for the user's feet 11 to rest without touching the ground, while still providing an area the user's feet 11 can travel as they slide onto and off of the seat 5. The wheels 2 may, however, be mounted to the mobility scooter 1 in any suitable manner allowing the user 6 to slide onto and off of the seat 5. This preferred variation of the mobility scooter 1 preferably allows users with limited or no use of one or more of their feet 11, legs, and lower body to use the mobility scooter 1, while still being able to slide onto and off of the seat 5 and onto one or more of furniture 8, toilets 9, and vehicle seats 5. This preferred variation may also enable those with limited strength in one or more of their feet 11, legs, and lower body to user 6 the mobility scooter 1. For users that may be paraplegic but have limited strength or mobility in their upper body, this preferred variation allows the user 6 to still be capable of getting around and using one or more of the furniture in their environment, the bathroom, and vehicles with little or no assistance. These same benefits may also be enabled for any user 6 that may have one or more of limited strength or mobility in their upper body, while also having limited or no use of one or more of their feet 11, legs, and lower body. The ability for users to slide backwards onto one or more of furniture 8, toilets 9, and vehicle seats 5 can allow users that previously were not able to get around with limited or no assistance to carry out virtually any important task in their lives that they were not capable of doing previously. Prior art scooters and wheelchairs require users with limited or no use of one or more of their feet 11, legs, and lower body to have significant mobility and strength in their upper body to get around comfortably, and to comfortably use any one of furniture in their environment, bathrooms, and vehicles. This preferred variation may, however, benefit any suitable users. This preferred variation may also, however, be used for any suitable purposes. As shown in FIG. 15, this preferred variation may further include a support and pad that are attached to one or more of the seat 5 and the frame 4, and positioned so that the user 6 can lean their chest against the pad. For a user 6 with limited or no use of one or more of their feet, legs, or lower body, it can be difficult for them to stabilize and support their upper body without their arms, so the support and pad may help the user 6 support and balance their upper body. In another variation, the pad may instead support the user 6 in contact with any other portion of the front of their torso, such as their abdomen or ribs. This preferred variation may, however, have any suitable means for helping the user 6 stabilize and support their upper body. This preferred variation may, however, have no means at all for helping the user 6 support and stabilize their upper body.

As a person skilled in the art will recognize from the previous detailed description and from the figures and claims, modifications and changes can be made to the preferred embodiments of the invention without departing from the scope of this invention defined in the following claims.

I claim:

1) A mobility scooter, wherein a set of at least two wheels are mounted on axles, wherein the axles are attached to a frame, wherein the frame supports a seat, wherein the seat has a shape adapted to allow a user to slide along the seat and off of at least one end of the seat.

2) The mobility scooter of claim 1, wherein the frame is positioned and adapted to allow the user to slide off of at least one end of the seat without being significantly obstructed by members of the frame.

3) The mobility scooter of claim 2, wherein the mobility scooter further comprises handles attached to the frame, wherein the handles are adapted to help the user direct the motion of the scooter.

4) The mobility scooter of claim 3, wherein the seat height is adapted to be similar to the height of at least one of A) common furniture, B) common toilets, C) common vehicle seats.

5) The mobility scooter of claim 4, wherein the frame and seat of the scooter are adapted to allow the scooter seat to be positioned close enough to at least one of A) common furniture, B) common toilets, and C) common vehicle seats such that the user can slide from the scooter seat onto at least one of A) common furniture, B) common toilets, and C) common vehicle seats.

6) The mobility scooter of claim 5, wherein the position of the seat is adapted to allow the user's feet to comfortably touch the ground, wherein the frame is adapted to allow the user to use their feet to freely provide motive force to the scooter.

7) The mobility scooter of claim 2, wherein the seat height is adapted to be similar to the height of at least one of A) common furniture, B) common toilets, C) common vehicle seats.

8) The mobility scooter of claim 7, wherein the frame and seat of the scooter are adapted to allow the scooter seat to be positioned close enough to at least one of A) common furniture, B) common toilets, and C) common vehicle seats such that the user can slide from the scooter seat onto at least one of A) common furniture, B) common toilets, and C) common vehicle seats.

9) The mobility scooter of claim 8, wherein the scooter has at least two wheels of sufficient size and adapted to allow the user to provide motive force to the scooter by turning said wheels with their hands.

10) The mobility scooter of claim 6, wherein the handles are positioned to help the user pull themselves onto the seat of the scooter when they are seated on another mode of seating.

11) The mobility scooter of claim 5, wherein the seat is mounted to an adjustable frame member, wherein the adjustable frame member is adapted to allow the seat height to be adjusted over a range of heights.

12) The mobility scooter of claim 9, wherein the seat is mounted to an adjustable frame member, wherein the adjustable frame member is adapted to allow the seat height to be adjusted over a range of heights.

13) The mobility scooter of claim 5, wherein the seat and frame are adapted to allow the user to slide off the back of the seat.

14) The mobility scooter of claim 9, wherein the seat and frame are adapted to allow the user to slide off the back of the seat.

15) The mobility scooter of claim 14, wherein a support member is attached to at least one of a) the frame and b) the seat and a pad is attached to the support member and positioned so that the user can lean at least one of their I) chest and II) abdomen against the pad and the pad will assist the user in supporting their upper body.
